(19) United States
(12) Patent Application Publication
(10) Pub. No.: US 2015/0215654 A1
(43) Pub. Date: Jul. 30, 2015

(54) PASSIVE VIEWING DATA COLLECTION IN A VIDEO PLACE-SHIFTING ENVIRONMENT

(71) Applicant: SLING MEDIA INC., Foster City, CA (US)

(72) Inventor: James Chihoon Kim, Redwood City, CA (US)

(21) Appl. No.: 14/162,836

(22) Filed: Jan. 24, 2014

(51) Int. Cl. H04N 21/233; H04N 21/25; H04N 21/2343; H04N 21/6377

(52) U.S. Cl. CPC H04N 21/233; H04N 21/6377; H04N 21/251; H04N 21/234309

(57) ABSTRACT

A method of processing video content is presented here. The method receives a video stream at a place-shifting device, identifies an audio segment of the received video stream, and communicates the identified audio segment to an automatic content recognition (ACR) system. In certain situations, the place-shifting device encodes the received video stream for transmission compatibility with a data communication network, obtains a network identifier of a remote user device, and provides the encoded video stream to the data communication network, using the network identifier for routing guidance. For such situations, the audio segment is communicated to the ACR system while the encoded video stream is being provided to the data communication network.

### TECHNICAL FIELD

Embodiments of the subject matter described herein relate generally to video services systems. More particularly, embodiments of the subject matter relate to an automatic content recognition technique for a video services system.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Video place-shifting techniques enable a subscriber of a video service to view programming content on a device that is remotely located, relative to the incoming source of video. A place-shifting device receives a source video stream, encodes the stream for transport over a network (such as the Internet), and sends the encoded video data to the user's remote device. Place-shifted video can be presented on a variety of user devices, such as a laptop computer, a mobile phone, a tablet computer, or the like.

### BRIEF SUMMARY

A method of processing video content may begin by receiving a video stream at a place-shifting device. The method continues by identifying an audio segment of the received video stream, encoding the received video stream for transmission compatibility with a data communication network, obtaining a network identifier of a remote user device, and providing the encoded video stream to the data communication network, using the network identifier for routing guidance. The method also communicates the identified audio segment to an automatic content recognition (ACR) system, wherein the communicating is performed while the encoded video stream is being provided to the data communication network.

A method of processing video content receives a video stream at a place-shifting device, and communicates an audio segment of the video stream from the place-shifting device to an automatic content recognition (ACR) system. The method continues by encoding the received video stream for transmission compatibility with a data communication network, obtaining a network identifier of a remote user device, and providing the encoded video stream to the data communication network, using the network identifier for routing guidance. The method continues by analyzing the audio segment to obtain a content identifier for a program conveyed in the received video stream, and by updating a database with an entry comprising the content identifier.

A system for processing video content includes a place-shifting device configured to receive a video stream from a media source, encode the received video stream for transmission compatibility with a data communication network, and communicate the encoded video stream to a remote user device, using the data communication network. The system also includes an automatic content recognition (ACR) system associated with the place-shifting device and configured to obtain, from the place-shifting device, an audio segment of the received video stream, and further configured to analyze the obtained audio segment to obtain a content identifier for a program conveyed in the received audio stream. The content identifier is obtained while the encoded video stream is being communicated to the remote user device.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates an exemplary embodiment of a video place-shifting system;

FIG. 2 is a block diagram that illustrates an exemplary embodiment of a video place-shifting environment; and

FIG. 3 is a flow diagram that illustrates an exemplary method of processing video content.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content conveyed in a video stream, the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based content delivery system, or the like. The disclosed subject matter relates to a system and related methodology for passively collecting user viewing data by way of a video content place-shifting device. More specifically, an automatic content recognition (ACR) system cooperates with one or more place-shifting devices that are assigned to subscribers of a video delivery service, e.g., a satellite or cable television provider. The ACR system analyzes video content as it is processed by the place-shifting device, i.e., while the video content is being encoded and transmitted to remote presentation devices operated by the subscribers of the video delivery service. The ACR system collects relevant data related to the viewing patterns and habits of the users (such as the particular video programs that were place-shifted, the presentation time/date, user identifiers, and the like). The collected information can be used to generate and provide programming recommendations for the subscribers. In certain embodiments, the collected information can be organized, formatted, or otherwise processed as needed. For example, service providers, advertisers, content providers and networks, and other consumers may be interested in the subscriber viewing data.

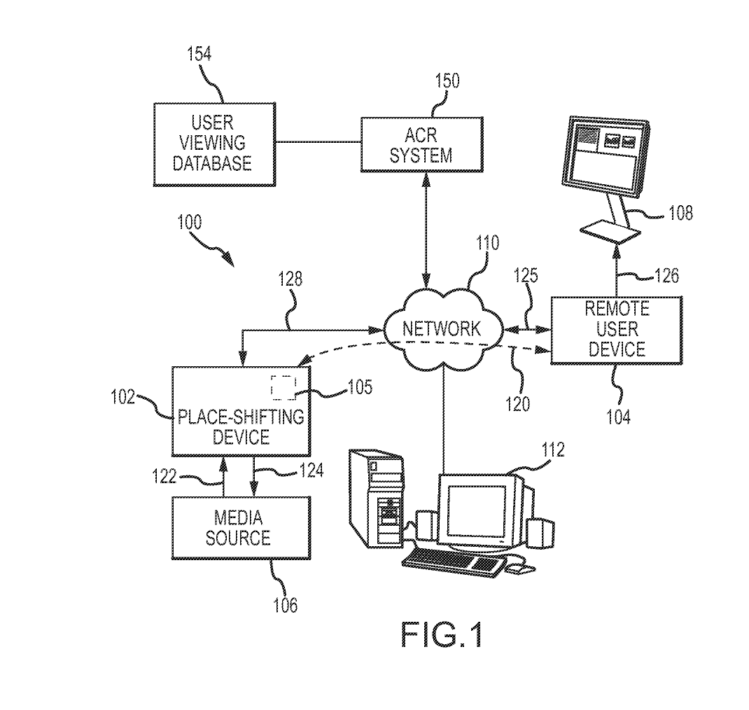

FIG. 1 is a block diagram that illustrates an exemplary embodiment of a video place-shifting system 100, which is suitably configured to provide media content to an end user. The system 100 can be utilized to carry out place-shifting and other processing of video content. Certain embodiments of the system 100 include a digital media processing device (e.g., a digital media place-shifting device 102) that receives a video stream 122 from a media source 106, encodes the received video stream 122 into a streaming format, and then transmits the encoded video stream 120 to a remotely-located digital media player or other presentation device over a data communication network 110. The presentation device is referred to herein as a remote user device 104. The remote user device 104 receives the encoded video stream 120, decodes the stream, and presents the decoded content to a viewer on a television or other display 108. Although not depicted in FIG. 1, the remote user device 104 includes or cooperates with at least one speaker, audio transducer, or other sound-generating element that supports the presentation of the audio portion of media streams. In various embodiments, a centralized mediation server device 112 may also be provided to communicate with the place-shifting device 102 and/or the remote user device 104 via the network 110 to assist these devices in locating each other, maintaining security, providing or receiving content or information, and/or any other features as desired.

The place-shifting device 102 is any component, hardware, software logic, etc., or any combination thereof, which is capable of transmitting a packetized stream of media content over the network 110. For example, the place-shifting device 102 may be a physically distinct component that is operatively coupled to a video services receiver (a set-top box) that serves as the media source 106. As another example, the place-shifting device 102 may be integrated with a video services receiver. In various embodiments, the place-shifting device 102 incorporates suitable encoder and/or transcoder (collectively “encoder”) logic to convert audio/video or other media content (e.g., the video stream 122) into a packetized format that can be transmitted over the network 110. The video stream 122 may be received in any format, and may be received from any internal or external media source 106 such as any sort of broadcast source, a cable or satellite television programming source, a “video-on-demand” or similar source, a digital video disk (DVD) or other removable media, a video camera, and/or the like. In some operating scenarios, a video stream received and processed by the place-shifting device 102 is a recorded video stream, which may be provided by the media source 106, by a digital video recorder module, by a video services receiver coupled to the place-shifting device 102, or the like. In this context, the recorded video stream could be realized as a locally recorded file, or it could be realized as an on-demand video stream. In some operating scenarios, a video stream received and processed by the place-shifting device 102 is a non-recorded broadcast video stream, which is currently being delivered by a video services system. The place-shifting device 102 encodes the video stream 122 to create the encoded video stream 120 in any manner. In various embodiments, the place-shifting device 102 contains a transmit buffer 105 that temporarily stores encoded data prior to transmission on the network 110.

In practice, an embodiment of the place-shifting device 102 may be implemented using any of the various SLINGBOX products available from Sling Media of Foster City, Calif., although other products could be used in other embodiments. Certain embodiments of the place-shifting device 102 are generally capable of receiving the video stream 122 from an external media source 106 such as any sort of digital video recorder (DVR), set top box (STB), cable or satellite programming source, DVD player, and/or the like. In such embodiments, the place-shifting device 102 may additionally provide commands 124 to the media source 106 to produce the desired video stream 122. Such commands 124 may be provided over any sort of wired or wireless interface, such as an infrared or other wireless transmitter that emulates remote control commands receivable by the media source 106. Other embodiments, however, may modify or omit this feature entirely.

In other embodiments, the functionality of the place-shifting device 102 may be integrated with any sort of content-receiving or other capabilities typically affiliated with the media source 106. Accordingly, the place-shifting device 102 may be a hybrid STB or other receiver, for example, that also provides transcoding and place-shifting features. Such a device may receive satellite, cable, broadcast and/or other signals that encode television programming or other content received from an antenna, modem, server and/or other source. A receiver of the place-shifting device 102 may further demodulate or otherwise decode the received signals to extract programming that can be locally viewed and/or place-shifted to the remote user device 104 as appropriate. In this regard, the place-shifting device 102 may also include a content database stored on a hard disk drive, memory, or other storage medium to support a personal or digital video recorder (DVR) feature or other content library as appropriate. Hence, in some embodiments, the media source 106 and the place-shifting device 102 may be physically and/or logically contained within a common component, housing or chassis.

In still other embodiments, the place-shifting device 102 includes or is implemented as a software program, applet, or the like executing on a conventional computing system (e.g., a personal computer). In such embodiments, the place-shifting device 102 may encode, for example, some or all of a screen display typically provided to a user of the computing system for place-shifting to a remote location. One device capable of providing such functionality is the SlingProjector product available from Sling Media of Foster City, Calif., which executes on a conventional personal computer, although other products could be used as well.

The remote user device 104 is any device, component, module, hardware, software, etc., or any combination thereof, which is capable of receiving the encoded video stream 120 from one or more place-shifting devices 102. In various embodiments, the remote user device 104 is personal computer (e.g., a “laptop” or similarly portable computer, although desktop-type computers could also be used), a mobile phone, a personal digital assistant, a personal media player, or the like. In many embodiments, the remote user device 104 is a general purpose computing device that includes a media player application in software or firmware that is capable of securely connecting to the place-shifting device 102, and is capable of receiving and presenting media content to the user of the device as appropriate. In other embodiments, however, the remote user device 104 is a standalone or other separate hardware device capable of receiving the encoded video stream 120 via any portion of the network 110 and decoding the encoded video stream 120 to provide an output signal 126 that is presented on the display 108. One example of a standalone remote user device 104 is the SLINGCATCHER product available from Sling Media of Foster City, Calif., although other products could be equivalently used.

The data communication network 110 is any digital or other communications network capable of transmitting messages between senders (e.g., the place-shifting device 102) and receivers (e.g., the remote user device 104). In various embodiments, the network 110 includes any number of public or private data connections, links or networks supporting any number of communications protocols. The network 110 may include the Internet, for example, or any other network based upon TCP/IP or other conventional protocols. In various embodiments, the network 110 also incorporates a wireless and/or wired telephone network, such as a cellular communications network for communicating with mobile phones, personal digital assistants, and/or the like. The network 110 may also incorporate any sort of wireless or wired local area networks, such as one or more IEEE 802.3 and/or IEEE 802.11 networks.

The place-shifting device 102 and/or the remote user device 104 are therefore able to communicate in any manner with the network 110 (e.g., using any sort of data communication links 128 and/or 125, respectively). Such data communication may take place over a wide area link that includes the Internet and/or a telephone network, for example; in other embodiments, communications between the place-shifting device 102 and the remote user device 104 may take place over one or more wired or wireless local area links that are conceptually incorporated within the network 110. In various equivalent embodiments, the place-shifting device 102 and the remote user device 104 may be directly connected via any sort of cable (e.g., an Ethernet cable or the like) with little or no other network functionality provided.

Many different place-shifting scenarios could be formulated based upon available computing and communications resources, consumer demand and/or any other factors. In various embodiments, consumers may wish to place-shift content within a home, office or other structure, such as from the place-shifting device 102 to a desktop or portable computer located in another room. In such embodiments, the content stream will typically be provided over a wired or wireless local area network operating within the structure. In other embodiments, consumers may wish to place-shift content over a broadband or similar network connection from a primary location to a computer or other remote user device 104 located in a second home, office, hotel or other remote location. In still other embodiments, consumers may wish to place-shift content to a mobile phone, personal digital assistant, media player, video game player, automotive or other vehicle media player, and/or other device via a mobile link (e.g., a GSM/EDGE or CDMA/EVDO connection, any sort of 3G or subsequent telephone link, an IEEE 802.11 “Wi-Fi” link, and/or the like). Several examples of place-shifting applications available for various platforms are provided by Sling Media of Foster City, Calif., although the concepts described herein could be used in conjunction with products and services available from any source.

The system 100 also includes an ACR system 150, which may be implemented as a centralized system or a distributed system. The ACR system 150 is operatively associated with, and communicatively coupled to, the place-shifting device 102. In this regard, the ACR system 150 communicates with the place-shifting device 102 using the data communication network 110. The ACR system 150 may also communicate with the remote user device 104 using the network 110. The ACR system 150 can be maintained and operated by the video services provider, a third party entity, a broadcast network, or the like.

The ACR system 150 includes or cooperates with a suitably formatted and configured user viewing database 154, which may be a central database, a local database integrated with the ACR system 150, a distributed database, or the like. The user viewing database 154 may be utilized to store information related to the operation of the place-shifting device 102, the operation of the remote user device 104, user viewing patterns, user viewing preferences, and the like. As described in more detail below, the user viewing database 154 can maintain entries for each user/subscriber of the video services system, wherein each entry includes information associated with the particular video content provided by the place-shifting device 102. The ACR system 150 functions to identify video content conveyed in the video stream output by the place-shifting device 102 and, in response to such identification, update the user viewing database 154 as needed. The analysis of video content and updating of the database 154 preferably occurs in an ongoing and passive manner in the background, and without any subscriber involvement or interaction.

The place-shifting device 102 can be implemented as (or is integrated with) an electronic processor-based component. Regardless of its form factor and hardware platform, the place-shifting device 102 is suitably configured to support the desired features and functions using the appropriate hardware, software, firmware, etc. For example, the place-shifting device 102 may include, without limitation: an input module or interface to receive the video stream 122 from the media source 106; a network communication module to interface with the data communication network 110; device-specific hardware, software, firmware, and/or applications; at least one processor; and at least one memory element having a suitable amount of storage capacity. These elements cooperate to encode the incoming video stream 122 into a format that can be transmitted over the network 110 to the remote user device 104. In addition, these elements may cooperate to identify or extract audio segments from the incoming video stream 122, and to communicate the identified audio segments from the place-shifting device 102 to the ACR system 150.

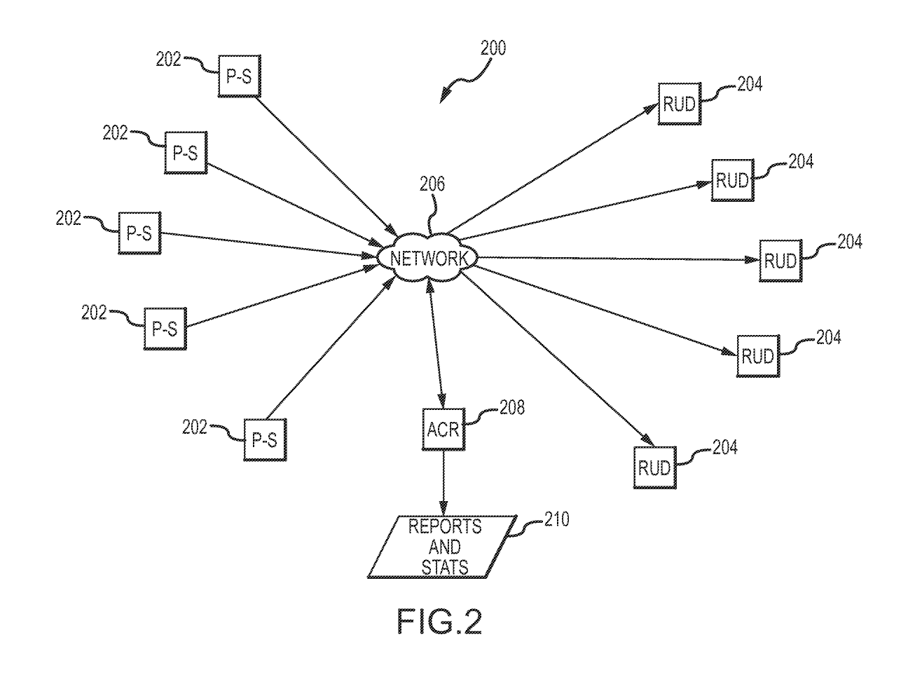

For simplicity, FIG. 1 only depicts one place-shifting device 102 and only one corresponding remote user device 104. In practice, a typical operating environment can support a large number of subscribers (end users). For example, a satellite or cable video services provider may support thousands of customers in a given region, and each customer may have one or more place-shifting devices 102 located at their home, office, etc. Furthermore, each customer may own or operate any number of different remote user devices 104. In this regard, FIG. 2 is a block diagram that illustrates an exemplary embodiment of a video place-shifting environment 200 that supports a plurality of place-shifting devices 202 and a plurality of remote user devices 204. The place-shifting devices 202 and the remote user devices 204 are communicatively coupled to a network 206, as mentioned above with reference to FIG. 1. Although FIG. 2 depicts only five place-shifting devices 202 and only five remote user devices 204, the place-shifting environment 200 can support any number of devices, and they need not be in a one-to-one relationship.

FIG. 2 also depicts an ACR system 208 that is communicatively coupled to the network 206 in a manner that enables it to cooperate with the place-shifting devices 202. Although not shown in FIG. 2, the ACR system 208 includes or cooperates with a suitably configured user viewing database (see FIG. 1). Notably, the ACR system 208 can receive segments of content (e.g., audio segments, video segments, one or more frames of audio/video data, one or more packets of audio/video data, or the like) from the place-shifting devices 202, analyze the segments, and update its user viewing database as needed to collect the desired information associated with the different users. In this context, the ACR system 208 serves as a centralized platform for analyzing the viewing statistics and viewing patterns of the subscribers. In practice, the functionality and processing power of the ACR system 208 can be scaled as needed to support the desired number of users and/or place-shifting devices 202.

In certain embodiments, the ACR system 208 can generate output 210 such as reports, statistics, graphs, charts, data structures, and the like. The particular type and format of the output 210 is unimportant for purposes of this description. The output 210 may be provided to any interested party, group, individual, entity, device, system, etc. For example, the output 210 could be generated and provided to the place-shifting devices 202 or to the remote user devices 204. As another example, the output 210 could be generated and provided to the video services provider. In certain situations, the output 210 may be generated and provided to advertisers, to a viewer rating or polling service, or the like.

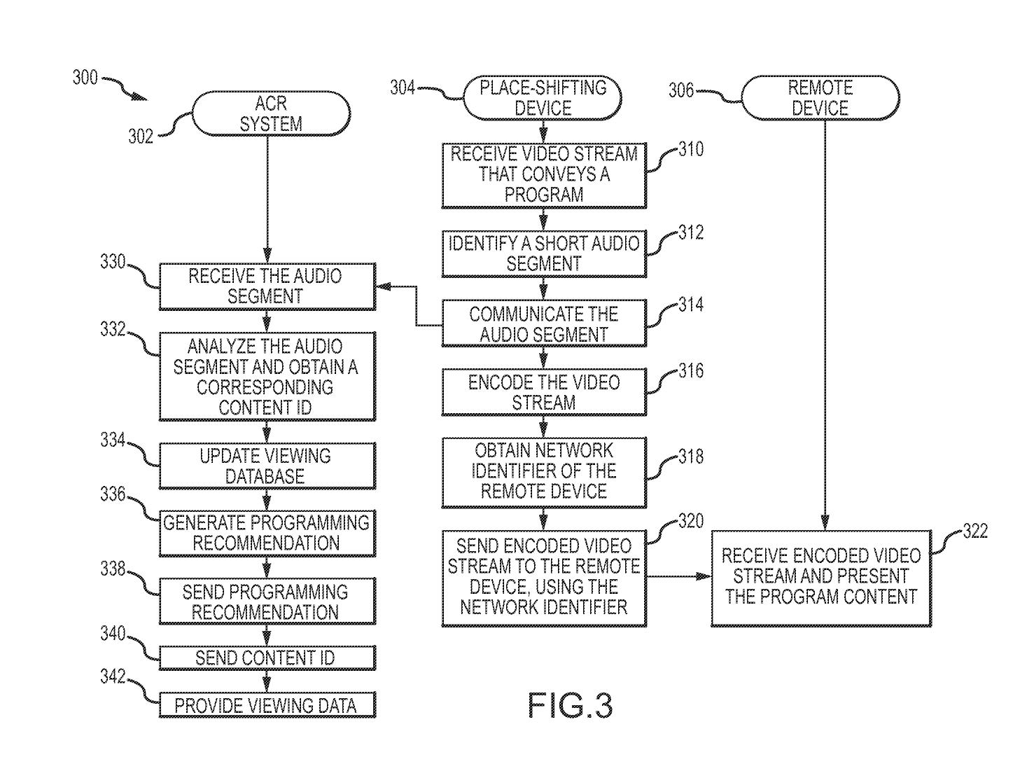

FIG. 3 is a flow diagram that illustrates exemplary processing of video content. The various tasks performed in connection with the process 300 shown in FIG. 3 may be performed by software, hardware, firmware, or any combination thereof For illustrative purposes, the following description of the process 300 may refer to elements mentioned above in connection with FIG. 1 and FIG. 2. In practice, portions of the process 300 may be performed by different elements of the described system, e.g., a place-shifting device, an ACR system, a remote user device, a backend server system, or the like. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

FIG. 3 shows certain tasks that might be performed by an ACR system 302, a place-shifting device 304, and a remote user device 306. The tasks performed by (or controlled by) the ACR system 302 are vertically aligned near the left side of FIG. 3. The tasks performed by (or controlled by) the place-shifting device 304 are vertically aligned near the center of FIG. 3. The task performed by (or controlled by) the remote user device 306 appears near the right side of FIG. 3.

The process 300 may be performed in an ongoing, continuous, or periodic manner in the background, and passively without any user knowledge or involvement. Thus, the process 300 may involve the place-shifting device 304 receiving a video stream that conveys programming content (task 310). The programming content conveyed in the video stream may be, without limitation: a television program or show; a movie; a music program; interstitial video content such as a commercial break, a sequence of individual commercials, or a trailer; an infomercial; or the like. In most typical operating scenarios, the video stream represents a broadcast video stream of audiovisual content that is being presented in a scheduled time slot. Alternatively, the video stream may be a recorded video stream that is being played back from the place-shifting device 304 or from a media storage or recording device that is in communication with the place-shifting device 304. As another example, the video stream may be an on-demand program that has been served to the place-shifting device 304 at the request of the user.

As the received video stream is being processed, the place-shifting device 304 identifies an audio segment of the video stream (task 312). The audio segment is directly obtained from the video stream data provided to the place-shifting device 304. In this regard, the audio segment is identified and captured internally by the place-shifting device 304; the audio information itself need not be played and sampled by a microphone. In some embodiments, the place shifting device 304 may identify a video segment, one or more video frames, or any identifiable portion of the video stream for purposes of the ACR methodologies described here.

The length of the audio segment should be long enough to enable the ACR system 302 to perform the required analysis, but short enough to enable efficient processing and handling. The specific length of the audio segment may vary from one embodiment to another, and may vary depending upon device configuration settings, user preferences, and the like. In certain embodiments, the process 300 relies on 21-second audio segments. In some embodiments, more than one audio segment can be sampled from the video stream for purposes of characterizing the video content or program. In contrast, only one sample may be required or possible to characterize a short piece of video content, such as a 30-second commercial.

The process 300 may be designed to capture the audio segment at any desired time. For example, the beginning of the audio segment may correspond to the start of the video segment under analysis. For that particular scenario, the place-shifting device 304 will determine or have knowledge of the beginning or transition point between segments of video content. As another example, the audio segment may begin at a point that occurs at some time after the beginning of the video content of interest, e.g., one second after the start time. As yet another example, the audio segment may be captured in accordance with a predetermined schedule or period. In accordance with some embodiments, task 312 may be initiated whenever the place-shifting device 304 is controlled to change channels or to otherwise begin processing a new video stream. In yet other embodiments, task 312 may be triggered whenever the place-shifting device 304 is activated or started.

In certain scenarios, the place-shifting device 304 continues to process and place-shift the video stream. Accordingly, the current video stream may be encoded for transmission compatibility with the data communication network (task 316). In certain embodiments, the place-shifting device 304 encodes the received video content into a packetized streaming format that can be transmitted over the network. The process 300 may obtain a network identifier (such as an Internet Protocol address) of the remote user device 306 for purposes of routing the encoded video stream (task 318). This allows the place-shifting device 304 to provide the encoded video stream to the data communication network, to send the encoded video stream to the remote user device 306 associated with that particular network identifier (task 320). Thus, the network identifier provides routing guidance such that the transmitted encoded video stream can reach the intended remote user device 306. The illustrated example assumes that the remote user device 306 receives the encoded video stream (task 322) and processes the encoded video stream in an appropriate manner to present the video content to the end user. In this regard, the remote user device 306 receives the encoded video stream, decodes the stream, and presents the decoded content to a viewer on a television set, a computer monitor, or other display device.

Although the illustrated embodiment of the process 300 assumes that the current video stream is place-shifted to the remote user device 306, place-shifting of the video content need not always take place. For example, the place-shifting device 304 could be configured to support playback of video content on a television set or other display that is coupled to the place-shifting device 304. In such an implementation, the content recognition techniques and methodologies described here can be equivalently applied to the video content even though it may not be provided to a remote device.

Notably, some of the processing tasks described here can be performed in parallel and concurrently by the different components. For example, the tasks related to the place-shifting and rendering of the video content can be performed while the captured audio segment is being communicated (task 314) from the place-shifting device 304 to the ACR system (302). Moreover, the various tasks performed by the ACR system 302 may be performed independently while the remainder of the video stream is processed, place-shifted, and presented to the user. This example assumes that the ACR system 302 successfully receives the audio segment from the place-shifting device 304 (task 330). As mentioned above, the audio segment may be communicated to the ACR system 302 while the encoded video stream is being provided to the remote user device 306.

The ACR system 302 analyzes the received audio segment to identify the video content from which the audio segment was taken (task 332). The ACR system 302 may leverage existing audio matching technologies to search a database of audio characteristics of known video content. The received audio segment is searched against this database to find a matching audio segment. When a match is found, the ACR system 302 obtains a content identifier (e.g., a Tribune Media Services ID or TMSID) that corresponds to the video content. The TMSID is a 14-character field that uniquely identifies a given program or show. In this regard, the ACR system 302 may include or have access to a database structure or table that includes all known content identifiers, along with other descriptive information associated with each content identifier, such as timestamp information, the title of the program content, the genre or category of the content, the publisher or network, the language of the program, etc.

The ACR system 302 may update the user viewing database (task 334) to indicate that the place-shifting device 304 is currently providing the identified video content to the subscriber. For example, the process 300 may update the user viewing database with an entry that includes the newly matched content identifier. In addition to the content identifier, the ACR system 302 may be designed to extract, receive, or otherwise obtain the start time, end time, and/or other timing information associated with the particular segment of video that is being processed.

The ACR system 302 (or another component or device in the system) may generate one or more programming recommendations for the user (task 336), where the programming recommendations may be based, at least in part, on the audio segment and/or on the corresponding content identifier. The ACR system 302 could send the programming recommendation (task 338) back to the place-shifting device 304 and/or to the remote user device 306 if so desired. In certain embodiments, the place-shifting device 304 forwards the programming recommendation to the remote user device 306 or to another device that is operated or owned by the subscriber. In such embodiments, the place-shifting device 304 provides the programming recommendation to the data communication network in an appropriate format, using the network identifier of the remote user device 306 for routing guidance.

Although not always required, the ACR system 302 may send the content identifier (task 340) to the place-shifting device 304, to the remote user device 306, and/or to other devices or systems if so desired. In such a scenario, the content identifier could be presented to the user, saved in a local database structure, or the like. Moreover, the ACR system 302 may be suitably configured to provide the collected user viewing data to an authorized person, entity, device, or system (task 342). As mentioned above with reference to FIG. 2, the ACR system 302 could generate reports or provide viewing statistics that consider the viewing patterns of any number of subscribers. Thus, although the process 300 has been described in the context of only one place-shifting device 304 and only one subscriber, it should be appreciated that the process 300 can be repeated as needed to continuously monitor place-shifted video streams generated by any number of place-shifting devices 304.

The above description assumes that the place-shifting devices perform the sampling and transmitting of the audio samples. In certain implementations, however, this functionality can be performed by one or more video services receivers (set-top boxes) in the system. Indeed, the functionality of the place-shifting devices may be deployed in a video services receiver. In some embodiments, the functionality described above could be distributed between a place-shifting device and a video services receiver. These and other possible implementations are contemplated by this disclosure.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of processing video content, the method comprising:
receiving a video stream at a place-shifting device;
identifying an audio segment of the received video stream;
encoding the received video stream for transmission compatibility with a data communication network, resulting in an encoded video stream;
obtaining a network identifier of a remote user device;
providing the encoded video stream to the data communication network, using the network identifier for routing guidance; and
communicating the identified audio segment to an automatic content recognition (ACR) system, wherein the communicating is performed while the encoded video stream is being provided to the data communication network.

2. The method of claim 1, wherein the received video stream comprises a recorded video stream.

3. The method of claim 1, wherein the received video stream comprises a broadcast video stream.

4. The method of claim 1, wherein the received video stream comprises an on-demand video stream.

5. The method of claim 1, further comprising:
receiving, at the place-shifting device, a content identifier for a program conveyed in the received video stream, wherein the content identifier is based on the identified audio segment, and wherein receiving the content identifier is performed after communicating the identified audio segment to the ACR system.

6. The method of claim 5, wherein the content identifier is received from the ACR system.

7. The method of claim 1, further comprising:
receiving, at the place-shifting device, a programming recommendation based on the identified audio segment; and
providing the programming recommendation to the data communication network, using the network identifier for routing guidance.

8. The method of claim 1, further comprising:
receiving, at the remote user device, a programming recommendation based on the identified audio segment.

9. A method of processing video content, the method comprising:
receiving a video stream at a place-shifting device;
communicating an audio segment of the video stream from the place-shifting device to an automatic content recognition (ACR) system;
analyzing the audio segment with the ACR system to obtain a content identifier for a program conveyed in the received video stream; and
updating a database with an entry comprising the content identifier.

10. The method of claim 9, wherein the received video stream comprises a recorded video stream.

11. The method of claim 9, wherein the received video stream comprises a broadcast video stream.

12. The method of claim 9, wherein the received video stream comprises an on-demand video stream.

13. The method of claim 9, further comprising:
generating a programming recommendation based on the audio segment;
sending the programming recommendation to the place-shifting device; and
thereafter, providing the programming recommendation to the data communication network, using the network identifier for routing guidance.

14. The method of claim 9, further comprising:
generating a programming recommendation based on the audio segment; and
sending the programming recommendation to the remote user device.

15. The method of claim 9, further comprising:
encoding the received video stream for transmission compatibility with a data communication network, resulting in an encoded video stream;
obtaining a network identifier of a remote user device; and
providing the encoded video stream to the data communication network, using the network identifier for routing guidance.

16. A system for processing video content, the system comprising:
a place-shifting device configured to receive a video stream from a media source, encode the received video stream for transmission compatibility with a data communication network, and communicate the encoded video stream to a remote user device, using the data communication network; and
an automatic content recognition (ACR) system associated with the place-shifting device and configured to obtain, from the place-shifting device, an audio segment of the received video stream, and further configured to analyze the obtained audio segment to obtain a content identifier for a program conveyed in the received audio stream, wherein the content identifier is obtained while the encoded video stream is being communicated to the remote user device.

17. The system of claim 16, wherein the ACR system is further configured to update a database with an entry that includes the content identifier.

18. The system of claim 16, wherein the ACR system is further configured to generate a programming recommendation based on the obtained content identifier.

19. The system of claim 18, wherein:
the ACR is further configured to send the programming recommendation to the place-shifting device; and
the place-shifting device is further configured to communicate the programming recommendation to the remote user device, using the data communication network.

20. The system of claim 18, wherein:
the ACR is further configured to send the programming recommendation to the remote user device, using the data communication network.
